(19) United States
(12) Patent Application Publication
(10) Pub. No.: US 2016/0198352 A1
(43) Pub. Date: Jul. 7, 2016

(54) System and Methods for Improving Data Performance Via Deliberate Hybrid Automatic Repeat Request (HARQ) Acknowledgment (ACK) and Fast Radio Link Control (RLC) Non-acknowledgment (NACK) in a Multi-Subscriber Identity Module (SIM) Wireless Communication Device

(71) Applicant: QUALCOMM Incorporated, San Diego, CA (US)

(72) Inventors: Ali Jarrahi Khameneh, San Diego, CO (US); Chintan Shirish Shah, San Diego, CA (US); Aziz Gholmieh, San Diego, CA (US); Mohammadamin Farajzadehjalali, San Diego, CA (US); Saket Bathwal, Hyderabad (IN); Reza Shahidi, San Diego, CA (US); Masoud Azmoodeh, San Diego, CA (US)

(21) Appl. No.: 14/741,980

(22) Filed: Jun. 17, 2015

Related U.S. Application Data
(60) Provisional application No. 62/099,779, filed on Jan. 5, 2015.

(51) Int. Cl. H04W 24/04; H04L 1/18

(52) U.S. Cl. CPC H04W 24/04; H04L 1/1812; H04W 24/08

(57) ABSTRACT

Methods and devices are disclosed for managing diversity tune-away on a wireless communication device configured with at least two radio frequency (RF) receive resources associated with a connection in a high speed data network. The wireless device may monitor data communications and downlink channel conditions in the high speed data network, and determine whether a diversity tune-away mode has been entered. Upon determining that the diversity tune-away mode has been entered, the wireless device may perform a deliberate acknowledgment procedure by ignoring normal error detection for received data and sending an acknowledgment message for the received data to the high speed data network. The wireless device may determine whether the diversity tune-away mode has ended, and in response to determining that the diversity tune-away mode has ended, and halt the deliberate acknowledgment procedure in response to determining that the diversity tune-away mode has ended.

### RELATED APPLICATIONS

This application claims the benefit of priority to U.S. Provisional Application No. 62/099,779 entitled “System and Methods for Improving LTE Data Performance Via Deliberate HARQ ACK and Fast RLC NACK in Multi-SIM Wireless Communication Device” filed Jan. 5, 2015, the entire contents of which are hereby incorporated by reference.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Mobile Telecommunications System (UMTS) Terrestrial Radio Access Network (UTRAN). The UTRAN is the radio access network (RAN) defined as a part of UMTS, a third generation (3G) mobile phone technology supported by the 3rd Generation Partnership Project (3GPP). UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). UMTS also supports enhanced 3G data communications protocols, such as High Speed Packet Access (HSPA), which provides higher data transfer speeds and capacity to associated UMTS networks.

Wireless communication devices may include multiple wireless antennas configured to receive data on a single wireless link. Receive diversity may enhance reliability by minimizing channel fluctuations due to fading. For example, multiple-input multiple-output (MIMO) operation may be used to receive wireless signals through multiple antennas at the same time corresponding to multiple transmitting antennas from the base station. MIMO operation takes advantage of receiving signals along multiple, different paths (multipath) that adds a spatial dimension to signal reception, which can be used in processing the received signals to increase performance.

Wireless communication devices may also include multiple wireless receive chains configured to receive data on more than one wireless link. For example, in some wireless communication systems or markets, a wireless service provider may implement more than one type of radio access technology or air interface protocol within a single system. Wireless communication devices that are configured with multiple receive paths may be capable of using one or more receive path to communicate on more than one radio access technology at a time. Such devices, which may be referred to as hybrid device, can therefore use a diversity antenna/receive chain to tune away to a network implemented by different carriers (e.g., using multiple subscriber identity modules (SIMs)), and/or the same carrier (e.g., in a hybrid system). In other wireless communication systems, wireless communication devices may be configured with multiple SIMs, each of which may be configure to communicate with different networks. Therefore, receive chain configurations may provide wireless communication devices with a variety of tune-away options, such as tuning away to a network associated with the same carrier, associated with a different carrier in the same radio access technology, associated with a different carrier in a different radio access technology, etc.

During such tune-aways, the wireless communication device may lose certain high-speed data capabilities in the downlink for the connected communication in the high-speed network, and may report lower channel quality indicator (CQI) and rank indicator (RI) values to the network.

### SUMMARY

Systems, methods, and devices of various embodiments enable a wireless communication device having at least two radio frequency (RF) receive resources to manage data throughput for a diversity tune-away mode by monitoring data communications and downlink channel conditions in a high speed data network, determining whether a diversity tune-away mode has been entered by the wireless communication device, performing a deliberate acknowledgment procedure in response to determining that the diversity tune-away mode has been entered, determining whether the diversity tune-away mode has ended on the wireless communication device, and halting the deliberate acknowledgment procedure and resuming normal error detection for the received data in response to determining that the diversity tune-away mode has ended. In some embodiment methods and devices, both the first RF resource and the second RF receive resources may be associated with a connection in the high speed data network. In some embodiment methods and devices, performing the deliberate acknowledgment procedure may include ignoring normal error detection for received data, and sending an acknowledgment message for the received data to the high speed data network.

In some embodiment methods and devices, transitioning to the diversity tune-away mode may include maintaining the association of the first RF receive resource with the connection to a Long Term Evolution (LTE) network, and tuning the second RF receive resource to a channel in a different network. In some embodiment methods and devices, the high speed data network may be associated with a first subscriber identity module (SIM) that supports a first second radio access technology (RAT), and tuning the second radio access technology RF receive resource to the channel in the different network may include using the second RF receive resource to enable a connection in a second RAT associated with a second SIM.

In some embodiment methods and devices, determining whether the wireless communication device is transitioning to a diversity tune-away mode may be based on a schedule or event associated with the second RAT. Systems, methods and devices of various embodiments further include reestablishing a normal receive mode on the wireless communication device by tuning the second RF receive resource to a channel associated with the connection in the high speed data network. Systems, methods and devices of various embodiments may further include continuing the deliberate acknowledgment procedure so long as the wireless communication device is in the diversity tune-away mode, that is throughout a diversity tune-away gap in which the diversity tune-away gap lasts until the wireless communication device transitions out of the diversity tune-away mode. In some embodiment methods and devices, the high speed data network is a network configured to use long term evolution (LTE) wireless communication protocols. In some embodiment methods and devices, ignoring normal error detection for received data may include bypassing hybrid automatic repeat request (HARQ) processes implemented by a media access control (MAC) protocol stack layer, and sending an acknowledgment message for the received data may include deliberately sending to the high speed data network acknowledgment (ACK) messages at the MAC layer regardless of errors in the received data.

In some embodiment methods and devices, performing the deliberate acknowledgment procedure may also include triggering or sending a status report message at a radio link control (RLC) protocol stack layer in which the status report messages alert the network of missed packets. In some embodiment methods and devices, sending the status report message at the RLC protocol stack layer may include periodically sending a fast RLC non-acknowledgment (NACK) message to the network automatically after each expiration of a predetermined time period.

Systems, methods and devices of various embodiments further include starting a first timer that lasts for a first preset period of time in response to determining that the diversity tune-away mode has been entered, determining whether the first preset period of time has expired, performing normal error detection processes for the received until the first preset period of time has expires, and beginning performing the deliberate acknowledgment procedure in response to determining that the first preset period of time has expired. Systems, methods and devices of various embodiments further include, upon expiration of the first preset period of time, starting a second timer that lasts a second preset period of time, determining whether the second preset period of time has expired, performing the deliberate acknowledgment procedure for the received data in response to determining that the second preset period of time has not expired, resuming performing the normal error detection processes the received data in response to determining that the second preset period of time has expired and repeating the first and second preset periods of time to alternate performing the normal error detection processes and the deliberate acknowledgment procedure. In some embodiment methods and devices the first period of time may be within the range of 20-30 ms, and the second period of time may be within the range of 10-20 ms.

Various embodiments include a wireless communication device including a wireless communication device configured with at least the first and second RF receive resources, and a processor configured with processor-executable instructions to perform operations of the methods as described. Various embodiments also include a non-transitory processor-readable medium on which is stored processor-executable instructions configured to cause a processor of a wireless communication device to perform operations of the methods as described. Various embodiments also include a wireless communication device having means for performing functions of the methods as described.

### BRIEF DESCRIPTION OF THE DRAWINGS

The accompanying drawings, which are incorporated herein and constitute part of this specification, illustrate exemplary embodiments, and together with the descriptions of various embodiments, serve to explain the features herein.

FIG. 1A is a communication system block diagram of a network suitable for use with various embodiments.

FIG. 1B is system block diagram of an Evolved Packet System (EPS) suitable for use with various embodiments.

FIG. 2 is a block diagram illustrating a wireless communication device according to various embodiments.

FIG. 3 is a block diagram illustrating the user plane Long Term Evolution (LTE) protocol stack according to various embodiments.

FIGS. 4A and 4B are process flow diagrams illustrating methods for implementing diversity tune-away management in an example wireless communication device according to various embodiments.

FIG. 5 is a component diagram of an example wireless device suitable for use with various embodiments.

FIG. 6 is a component diagram of another example wireless device suitable for use with various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Systems, methods, and devices of various embodiments enable a wireless communication device having at least two radio frequency (RF) receive resources to manage data throughput for a diversity tune-away mode by performing a deliberate acknowledgment procedure whenever a diversity tune-away mode is implemented. The deliberate acknowledgment procedure includes sending a receipt acknowledgment (ACK) message or messages, even though the data was not received due to the tune-away, followed soon thereafter by a non-receipt (NACK) message or messages in order to prompt the network to retransmit the data that was not received. The various embodiments improve the operation of wireless communication devices in high-speed wireless networks by avoiding some of the problems that can arise during diversity tune-away.

As used herein, the terms “SIM,” “SIM card,” and “subscriber identity module” are used interchangeably to refer to a memory that may be an integrated circuit or embedded into a removable card, and that stores an International Mobile Subscriber Identity (IMSI), related key, and/or other information used to identify and/or authenticate a wireless device on a network and enable a communication service with the network. Because the information stored in a SIM enables the wireless device to establish a communication link for a particular communication service or services with a particular network, the term “SIM” is also be used herein as a shorthand reference to the communication service associated with and enabled by the information stored in a particular SIM as the SIM and the communication network, as well as the services and subscriptions supported by that network, correlate to one another. Similarly, the term SIM may also be used as a shorthand reference to the protocol stack and/or modem stack and communication processes used in establishing and conducting communication services with subscriptions and networks enabled by the information stored in a particular SIM.

As used herein, the terms “multi-SIM wireless communication device,” “multi-SIM wireless device,” and “dual-SIM wireless communication device,” are used interchangeably to describe a wireless device that is configured with more than one SIM.

As used herein, the terms “multi-SIM multi-active communication device” and “MSMA communication device” are used interchangeably to refer to a multi-SIM wireless communication device that is configured to use separate RF resources to independently handle communications with networks of two or more subscriptions. Dual-SIM dual-active (DSDA) communication devices are an example of a type of MSMA communication device.

The terms “wireless network,” “cellular network,” and “cellular wireless communication network” are used interchangeably herein to refer to a portion or all of a wireless network of a carrier associated with a wireless device and/or subscription on a wireless device.

The terms “multiple-input multiple-output” and “MIMO” are used interchangeably herein to refer to a technology that multiplies the capacity of a radio link by exploiting multipath propagation. In particular, a wireless communication device operating in MIMO mode employs multiple radio frequency (RF) chains to receive and combine data streams arriving from different downlink paths, and/or to create multiple data streams for transmission on different uplink paths. When there are more antennas than data streams, the antennas can add receiver diversity and increase range.

As used herein, the terms “diversity,” “receive diversity,” “diversity reception,” and “receiver diversity” are used interchangeably to refer to processing a downlink/forward link signal by input to multiple receive chains in a wireless communication device. For example, at least two antennas provide at least two different inputs signals to a receiver, each of which has a different multi-path.

Wireless communication networks are widely deployed to provide various communication services such as voice, packet data, broadcast, messaging, and so on. These wireless networks may be capable of supporting communications for multiple users by sharing the available network resources. Examples of such wireless networks include the Global System for Mobile Communications (GSM), Code Division Multiple Access (CDMA) networks, Time Division Multiple Access (TDMA) networks, and Frequency Division Multiple Access (FDMA) networks. Wireless networks may also utilize various radio technologies such as Wideband-CDMA (W-CDMA), CDMA2000, Global System for Mobile Communications (GSM), etc. While reference may be made to procedures set forth in GSM standards such references are provided merely as examples, and the claims encompass other types of cellular telecommunication networks and technologies.

Modern mobile communication devices (e.g., smartphones) may each include one or more SIM cards containing SIMs that enable a user to connect to different mobile networks while using the same mobile communication device. Each SIM serves to identify and authenticate a subscriber using a particular mobile communication device, and each SIM is associated with only one subscription. For example, a SIM may be associated with a subscription to one of GSM, TD-SCDMA, CDMA2000, and W-CDMA.

As used herein, the term “RF resource” refers to the components in a wireless communication device that send, receive, and decode radio frequency signals. An RF resource typically includes a number of components coupled together that transmit RF signals that are referred to as a “transmit chain,” and a number of components coupled together that receive and process RF signals that are referred to herein as a “receive chain.”

While specific receiver operations may be described herein with reference to a degree of two (i.e., two RF resources, two antennas, two receive chains, etc.), such references are used as example and are not meant to preclude embodiments using three or more RF resources. The terms “receiver” and/or “transmitter” may respectively indicate a receive chain and/or transmit chain, and/or portions thereof in use for radio links. Such portions of the receive chain and/or transmit chain may be parts of the RF resource that include, without limitation, an RF front end, components of the RF front end (including a receiver unit and/or transmitter unit), antennas, etc. Portions of a receive chain and/or transmit chain may be integrated into a single chip, or distributed over multiple chips. Also, the RF resource, or the parts of the RF resource, may be integrated into a chip along with other functions of the wireless device. Further, in some embodiment wireless systems, the wireless communication device may be configured with more RF resources than spatial streams, thereby enabling receive and/or transmit diversity to improve signal quality.

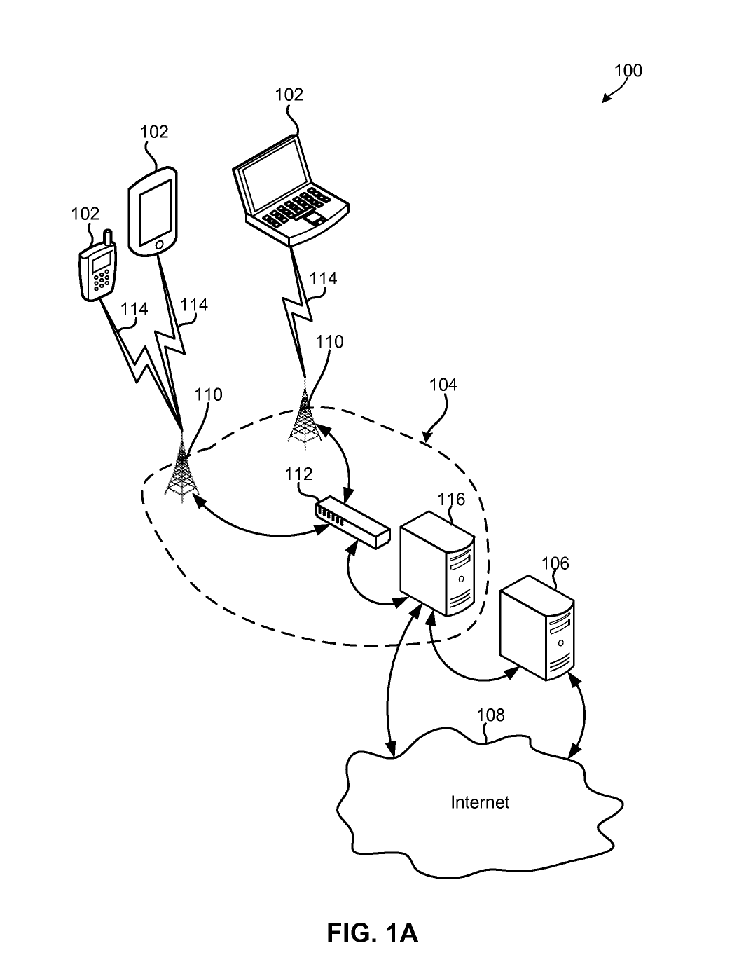

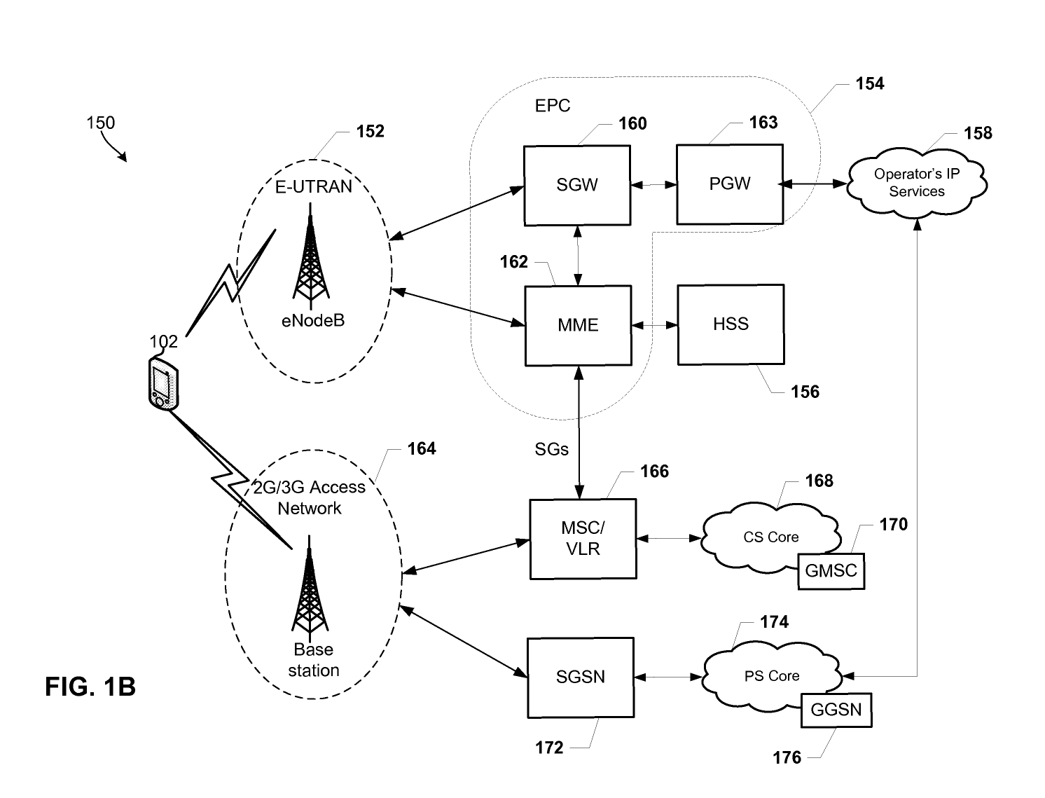

Various embodiments may be implemented within a variety of communication systems, such as the example communication system 100 illustrated in FIG. 1A. The communication system 100 may include one or more wireless communication devices 102, a telephone network 104, and network servers 106 coupled to the telephone network 104 and to the Internet 108. In some embodiments, the network server 106 may be implemented as a server within the network infrastructure of the telephone network 104.

A typical telephone network 104 may include a plurality of cell base stations 110 coupled to a network operations center 112, which operates to connect voice and data calls between the wireless communication devices 102 (e.g., tablets, laptops, cellular phones, etc.) and other network destinations, such as via telephone land lines (e.g., a POTS network, not shown) and the Internet 108. The telephone network 104 may also include one or more servers 116 coupled to or within the network operations center 112 that provide a connection to the Internet 108 and/or to the network servers 106. Communications between the wireless communication devices 102 and the telephone network 104 may be accomplished via two-way wireless communication links 114, such as GSM, UMTS, CDMA, TDMA, LTE, and/or other communication technologies.

In general, any number of wireless networks may be deployed in a given geographic area. Each wireless network may support one or more radio access technology, which may operate on one or more frequency (also referred to as a carrier, channel, frequency channel, etc.) in the given geographic area in order to avoid interference between wireless networks of different radio access technologies.

Upon power up, the wireless communication device 102 may search for wireless networks from which the wireless communication device 102 can receive communication service. In various embodiments, the wireless communication device 102 may be configured to prefer LTE networks when available by defining a priority list in which LTE frequencies occupy the highest spots. The wireless communication device 102 may perform registration processes on one of the identified networks (referred to as the serving network), and the wireless communication device 102 may operate in a connected mode to actively communicate with the serving network. Alternatively, the wireless communication device 102 may operate in an idle mode and camp on the serving network if active communication is not required by the wireless communication device 102. In the idle mode, the wireless communication device 102 may identify all RATs in which the wireless communication device 102 is able to find a “suitable” cell in a normal scenario or an “acceptable” cell in an emergency scenario, as specified in the LTE standards, such as 3GPP TS 36.304 version 8.2.0 Release 8, entitled “LTE; Evolved Universal Terrestrial Radio Access (E-UTRA); User Equipment (UE) procedures in idle mode.”

The wireless communication device 102 may camp on a cell belonging to the RAT with the highest priority among all identified. The wireless communication device 102 may remain camped until either the control channel no longer satisfies a threshold signal strength or a cell of a higher priority RAT reaches the threshold signal strength. Such cell selection/reselection operations for the wireless communication device 102 in the idle mode are also described in 3GPP TS 36.304 version 8.2.0 Release 8.

FIG. 1B illustrates a network architecture 150 that includes an Evolved Packet System (EPS). With reference to FIGS. 1A-1B, in the network architecture 150 the wireless communication device 102 may be connected to an LTE access network, for example, an Evolved UMTS Terrestrial Radio Access Network (E-UTRAN) 152. In the various embodiments, the E-UTRAN 152 may be a network of LTE base stations (i.e., eNodeBs) (e.g., 110 in FIG. 1A), which may be connected to one another via an X2 interface (e.g., backhaul) (not shown).

In various embodiments, each eNodeB may provide to wireless devices an access point to an LTE core (e.g., an Evolved Packet Core). For example, the EPS in the network architecture 150 may further include an Evolved Packet Core (EPC) 154 to which the E-UTRAN 152 may connect. In various embodiments, the EPC 154 may include at least one Mobility Management Entity (MME) 162, a Serving Gateway (SGW) 160, and a Packet Data Network (PDN) Gateway (PGW) 163.

In various embodiments, the E-UTRAN 152 may connect to the EPC 154 by connecting to the SGW 160 and to the MME 162 within the EPC 154. The MME 162, which may also be logically connected to SGW 160, may handle tracking and paging of the wireless communication device 102 and security for E-UTRAN access on the EPC 154. The MME 162 may be linked to a Home Subscriber Server (HSS) 156, which may support a database containing user subscription, profile, and authentication information. Further, the MME 162 provides bearer and connection management for user IP packets, which are transferred through the SGW 160. In various embodiments, the SGW 160 may be connected to the PGW 163, which may provide IP address allocation to the wireless communication device 102, as well as other functions. The PGW 163 may be connected to the Operator's IP Services 158, which may include, for example, the Internet, an Intranet, an IP Multimedia Subsystem (IMS), a PS Streaming Service (PSS), etc.

The network architecture 150 may also include circuit-switched (CS) and packet-switched (PS) networks. In some embodiments, the wireless communication device 102 may be connected to the CS and/or PS packet switched networks by connecting to a legacy second generation (2G)/third generation (3G) access network 164, which may be one or more UTRAN, GSM Enhanced Data rates for GSM Evolution (EDGE) Radio Access Network (GERAN), etc. In various embodiments, the 2G/3G access network 164 may include a network of base stations (e.g., base transceiver stations (BTSs), nodeBs, radio base stations (RBSs), etc.) (e.g., 110), as well as at least one base station controller (BSC) or radio network controller (RNC) (not shown). In various embodiments, the 2G/3G access network 164 may connect to the circuit switched network via an interface with (or gateway to) a Mobile switching center (MSC) and associated Visitor location register (VLR), which may be implemented together as MSC/VLR 166. In the CS network, the MSC/VLR 166 may connect to a CS core 168, which may be connected to external networks (e.g., the public switched telephone network (PSTN)) through a Gateway MSC (GMSC) 170.

In various embodiments, the 2G/3G access network 164 may connect to the PS network via an interface with (or gateway to) a Serving general packet radio service (GPRS) support node (SGSN) 172, which may connect to a PS core 174. In the PS network, the PS core 174 may be connected to external PS networks, such as the Internet and the Operator's IP services 158 through a Gateway GPRS support node (GGSN) 176.

A number of techniques may be employed by LTE network operators to enable voice calls to the wireless communication device 102 when camped on the LTE network (e.g., EPS). The LTE network (e.g., EPS) may co-exist in mixed networks with the CS and PS networks, with the MME 162 serving the wireless communication device 102 for utilizing PS data services over the LTE network, the SGSN 172 serving the wireless communication device 102 for utilizing PS data services in non-LTE areas, and the MSC/VLR 166 serving the wireless communication device 102 for utilizing voice services. In various embodiments, the wireless communication device 102 may be able to use a single RF resource for both voice and LTE data services by implementing circuit-switched fallback (CSFB) to switch between accessing the E-UTRAN 152 and the legacy 2G/3G access network 164.

The mixed network may be enabled to facilitate CSFB via an interface (SGs) between the MME 162 and the MSC/VLR 166. The interface enables the wireless communication device 102 to utilize a single RF resource to be both CS and PS registered while camped on the LTE network, which enables delivery CS pages via the E-UTRAN 152. A CS page may initiate the CSFB procedure, which may cause the wireless device to transition to the CS network and utilize the CS call setup procedures.

In various embodiments, modulation and multiple access schemes may be employed by a high speed access network (e.g., E-UTRAN 152) and may vary depending on the particular telecommunications standard being deployed. For example, in LTE applications, orthogonal frequency-division multiple access (OFDMA) may be used on the downlink, while single-carrier frequency-division multiple access (SC-FDMA) may be used on the uplink to support both frequency division duplexing (FDD) and time division duplexing (TDD). Those of ordinary skill in the art will appreciate that while the various embodiments herein may be described with respect to LTE, such embodiments but may be extended to other telecommunication standards employing other modulation and multiple access techniques. By way of example, the various embodiments may be extended to Evolution-Data Optimized (EV-DO) and/or Ultra Mobile Broadband (UMB), each of which are air interface standards promulgated by the 3rd Generation Partnership Project 2 (3GPP2) as part of the CDMA2000 family to provide broadband Internet access to wireless devices. The various embodiments may also be extended to Universal Terrestrial Radio Access (UTRA) employing Wideband-CDMA (W-CDMA), GSM, Evolved UTRA (E-UTRA), Ultra Mobile Broadband (UMB), IEEE 802.11 (Wi-Fi), IEEE 802.16 (WiMAX), IEEE 802.20, and/or Flash-OFDM employing OFDMA. The actual wireless communication standard and the multiple access technology employed depend on the specific application and the overall design constraints imposed on the system.

In some embodiments, access network entities (e.g., eNodeBs) may have multiple antennas supporting MIMO technology, thereby enabling the eNodeBs to exploit the spatial domain to support spatial multiplexing, beamforming, and/or transmit diversity. Spatial multiplexing may be used to transmit different streams of data simultaneously on the same frequency. In some instances, the data steams may be transmitted to a single wireless communication device to increase the data rate, while in other instances the data streams may be transmitted to multiple wireless communication devices to increase the overall system capacity. Specifically, an eNodeB may spatially precode each data stream and transmit each spatially precoded data stream through multiple transmit antennas on the downlink. The spatially precoded data streams may arrive at the one or more wireless communication device with different spatial signatures, enabling recovery of the one or more data streams destined for that device or antenna. On the uplink, each wireless communication device may transmit a spatially precoded data stream, which enables the eNodeB to identify the source of each received data stream. In some embodiments, when channel conditions are unfavorable, beamforming may be used by the eNodeB to focus transmission energy in one or more direction. In various embodiments, beamforming may involve spatially precoding the data for transmission through multiple antennas. In some embodiments, to achieve good coverage at the edges of the cell, a single stream beamforming transmission may be used in combination with transmit diversity (e.g., sending the stream to the same source through multiple antennas).

Various embodiments may be implemented in LTE-Advanced wireless networks that have been deployed or that may be deployed in the future. LTE-Advanced communications typically use spectrum in up to 20 MHz bandwidths allocated in a carrier aggregation of up to a total of 100 MHz (5 component carriers) used for transmission in each direction. Such LTE-Advanced systems may utilize one or more of two types of carrier aggregation, non-continuous and continuous. Non-continuous carrier aggregation involves aggregating available component carriers (inter- or intra-band) that are separated in the frequency spectrum, while continuous carrier aggregation involves multiple available component carriers that are adjacent to each other. Both non-continuous and continuous carrier aggregation may aggregate multiple LTE/component carriers to serve a wireless communication device using the LTE-Advanced protocol.

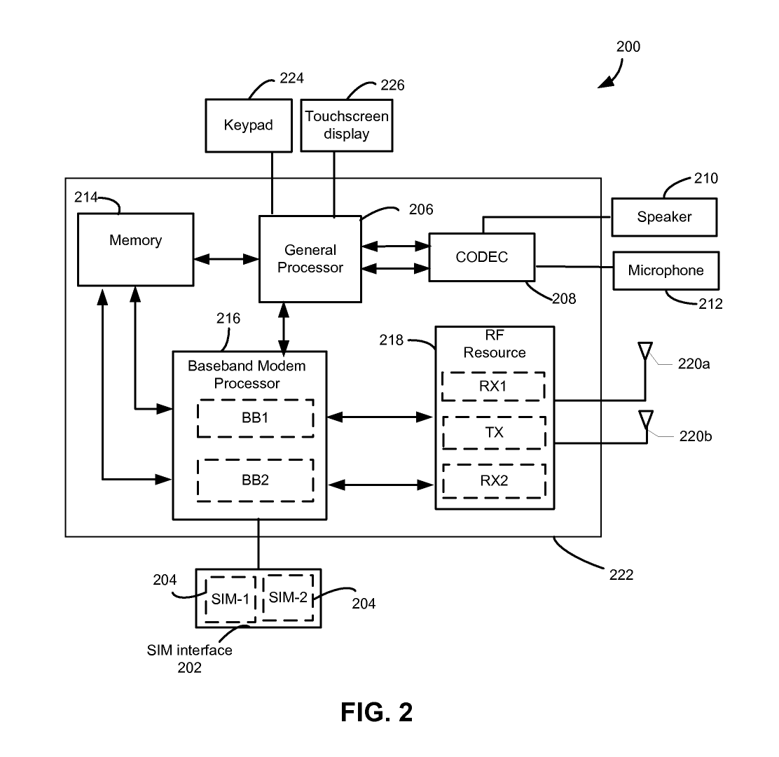

FIG. 2 is a functional block diagram of an example multi-SIM wireless device 200 that is suitable for implementing various embodiments. With reference to FIGS. 1A-2, the wireless device 200 may be similar to one or more of the wireless communication devices 102 as described. The wireless device 200 may include a SIM interface 202, which may represent either one or two (or more) SIM interfaces. The SIM interface 202 may receive a first identity module SIM 204 that is associated with the first subscription. In some embodiments, the wireless device 200 may also include a second SIM interface as part of the SIM interface 202, which may receive a second identity module SIM 204 that is associated with a second subscription.

A SIM in various embodiments may be a Universal Integrated Circuit Card (UICC) that is configured with SIM and/or USIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card.

Each SIM 204 may have a CPU, ROM, RAM, EEPROM and I/O circuits. A SIM 204 used in various embodiments may contain user account information, an IMSI a set of SIM application toolkit (SAT) commands and storage space for phone book contacts. A SIM 204 may further store home identifiers (e.g., a System Identification Number (SID)/Network Identification Number (NID) pair, a Home PLMN (HPLMN) code, etc.) to indicate the SIM network operator provider. An Integrated Circuit Card Identity (ICCID) SIM serial number may be printed on the SIM card for identification.

The wireless device 200 may include at least one controller, such as a general purpose processor 206, which may be coupled to a coder/decoder (CODEC) 208. The CODEC 208 may in turn be coupled to a speaker 210 and a microphone 212. The general purpose processor 206 may also be coupled to at least one memory 214. The memory 214 may be a non-transitory tangible computer readable storage medium that stores processor-executable instructions. For example, the instructions may include routing communication data relating to the first or second subscription though a corresponding baseband-RF resource chain. The memory 214 may store operating system (OS), as well as user application software and executable instructions.

The general purpose processor 206 and the memory 214 may each be coupled to at least one baseband-modem processor 216. Each SIM 204 in the wireless device 200 may be associated with a baseband-RF resource chain that includes a baseband-modem processor 216 and at least one receive block (e.g., RX1, RX2) of an RF resource 218. In various embodiments, baseband-RF resource chains may include physically or logically separate baseband modem processors (e.g., BB1, BB2).

The RF resource 218 may be coupled to antennas 220a, 220b and may perform transmit/receive functions for the wireless services associated with each SIM 204 of the wireless device 200. In some embodiments, the RF resource 218 may be coupled to the antennas 220a, 220b for sending and receiving RF signals for the SIM(s) 204, thereby enabling the wireless device 200 to perform simultaneous communications with separate networks and/or service associated with the SIM(s) 204. The RF resource 218 may include separate receive and transmit functionalities, or the RF resource 218 may include a transceiver that combines transmitter and receiver functions. In various embodiments, the transmit functionalities of the RF resource 218 may be implemented by at least one transmit block (TX), which may represent circuitry associated with one or more radio access technologies/SIMs

In particular embodiments, the general purpose processor 206, memory 214, baseband-modem processor(s) 216, and RF resource 218 may be included in a system-on-chip device 222. The one or more SIM 204 and corresponding interface(s) 202 may be external to the system-on-chip device 222. Further, various input and output devices may be coupled to components of the system-on-chip device 222, such as interfaces or controllers. Example user input components suitable for use in the wireless device 200 may include, but are not limited to, a keypad 224 and a touchscreen display 226.

In some embodiments, the keypad 224, touchscreen display 226, microphone 212, or a combination thereof, may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or to receive a telephone number. As another example, the request to initiate the outgoing call may be in the form of a voice command received via the microphone 212. Interfaces may be provided between the various software modules and functions in the wireless device 200 to enable communication between them, as is known in the art.

The baseband-modem processor of a wireless communication device may be configured to execute software including at least one protocol stack associated with at least one SIM. SIMs and associated protocol stacks may be configured to support a variety of communication services that fulfill different user requirements. Further, a particular SIM may be provisioned with information to execute different signaling procedures for accessing a domain of the core network associated with these services and for handling data thereof.

As described, a wireless communication device in the various embodiments may support a number of radio access technologies (RATs) to support communication with different wireless networks. For example, the radio technologies may include a wide area network (e.g., third generation partnership project (3GPP) long term evolution (LTE) or 1× radio transmission technology (1×)), wireless local area network (WLAN), Bluetooth and/or the like. Multiple antennas and/or receive blocks may be provided to facilitate multimode communication with various combinations of antenna and receiver/transmitter configurations. Each radio technology may transmit or receive signals via one or more antennas.

In various embodiments, the RF resource 218 may be configured with receiver and transmitter circuitry to support multiple radio access technologies/wireless networks that operate according to different wireless communication protocols. Such circuitry may allow the RF resource 218 to process signals associated with different communication standards, and may include or provide connections to different sets of amplifiers, digital to analog converters, analog to digital converters, filters, voltage controlled oscillators (VCOs), etc. In some embodiments, a first receive block (RX1) and a transmit block (TX) may operate as a pair for transmission and reception of RF signals via a first antenna (e.g., 220a) in accordance with a high-speed data network, such as an LTE network. That is, various embodiments may include a first receive chain and a transmit chain that are each configured to primarily communicate with the LTE network. Further, a second receive block (RX2) may be coupled to a second antenna (i.e., forming a second receive chain) (e.g., 220b), and may be configured to operate in cooperation with the transmit block and first receive block to provide dual receive capability (e.g., as used in MIMO reception and with receiver diversity). In various embodiments, the first and second receive blocks may be configured to utilize the same or different of various radio receiver elements. For example, for MIMO/diversity receive operations, the first and second receive blocks may respectively use the first and second antennas to tune to and receive signals on the same LTE carrier frequency using a single VCO.

In some embodiments, the first and second receive blocks may respectively use the first and second antennas to tune to and receive signals on different carrier frequencies using separate VCOs. In some embodiments, a different carrier frequency may be an LTE carrier frequency in the same or in a different band, thereby providing support for an LTE wireless network that uses carrier aggregation to combine information transmitted on two or more carrier frequencies. In some embodiments in which two different carrier frequencies are received in a carrier aggregation mode, the first and second antennas may each be shared between the first and second receive blocks. In this manner, each antenna may be able to support two receive chains (i.e., one for each carrier frequency), thereby supporting antenna diversity on both carrier frequencies.

In other embodiments, the different carrier frequency may be a channel in another RAT (e.g., using CDMA2000, UMTS, GSM). In this manner, the additional receiver may achieve a downlink connection for a legacy network simultaneous to maintaining uplink and downlink communications on the LTE network. However, with only one receive chain allocated for LTE communication, diversity/MIMO operation is disabled for downlink communications on the LTE network. As a result the wireless device may provide a rank indicator (RI) value in a channel status report or to provide another signaling control message to the LTE wireless network indicating an inability to decode higher MCS downlink data.

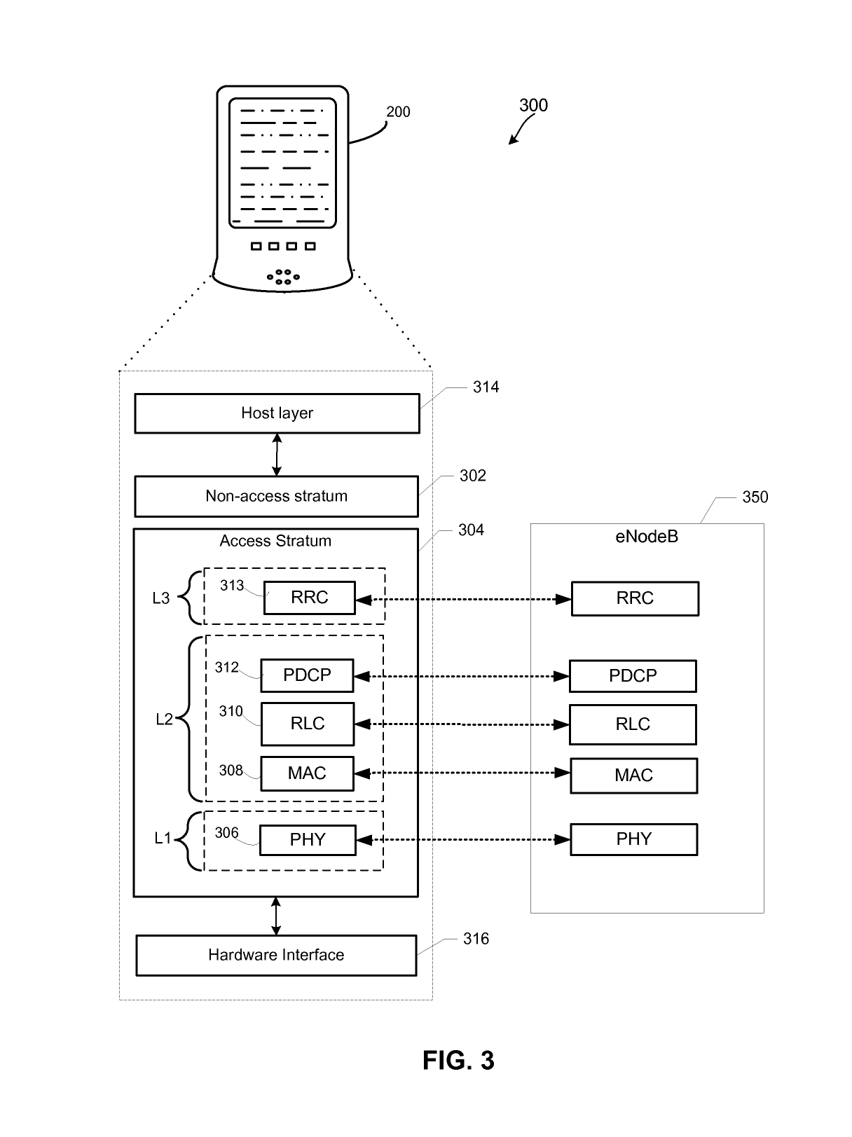

FIG. 3 illustrates an example of a radio protocol stack for the user and control planes in LTE. With reference to FIGS. 1-3, the wireless device 200 may implement software architecture 300 to communicate with an eNodeB 350 of an access network (e.g., E-UTRAN 152) associated with one or more SIM. In various embodiments, layers in software architecture 300 may form logical connections with corresponding layers in software of the eNodeB 350. The software architecture 300 may be distributed among one or more processors, such as the baseband modem processor 216. While illustrated with respect to one radio protocol stack, in a multi-SIM wireless device, the software architecture 300 may include multiple protocol stacks, each of which may be associated with a different SIM (e.g., two protocol stacks associated with two SIMs 204, respectively, in a dual-SIM wireless communication device). Further, while described below with reference to LTE communication layers, the software architecture 300 may support any of variety of standards and protocols for wireless communications, and/or may include additional protocol stacks that support any of variety of standards and protocols wireless communications.

The software architecture 300 may include a Non Access Stratum (NAS) 302 and an Access Stratum (AS) 304. The NAS 302 may include functions and protocols to support packet filtering, security management, mobility control, session management, and traffic and signaling between a SIM(s) of the wireless device (e.g., SIM(s) 204) and its core network. The AS 304 may include functions and protocols that support communication between a SIM(s) (e.g., SIM(s) 204) and entities of supported access networks (e.g., an eNodeB). In particular, the AS 304 may include at least three layers (Layer 1, Layer 2, and Layer 3), each of which may contain various sub-layers.

In the user and control planes, Layer 1 (L1) of the AS 304 may be a physical layer 306, which may oversee functions that enable transmission and/or reception over the air interface. Examples of such physical layer 306 functions may include cyclic redundancy check (CRC) attachment, coding blocks, scrambling and descrambling, modulation and demodulation, signal measurements, MIMO, etc.

In the user and control planes, Layer 2 (L2) of the AS 304 may be responsible for the link between the wireless device 200 and the eNodeB 350 over the physical layer 306. In the various embodiments, Layer 2 may include a media access control (MAC) sublayer 308, a radio link control (RLC) sublayer 310, and a packet data convergence protocol (PDCP) 312 sublayer, each of which form logical connections terminating at the eNodeB 350.

In the control plane, Layer 3 (L3) of the AS 304 may include a radio resource control (RRC) sublayer 3. While not shown, the software architecture 300 may include additional Layer 3 sublayers, as well as various upper layers above Layer 3. In various embodiments, the RRC sublayer 313 may provide functions including broadcasting system information, paging, and establishing and releasing an RRC signaling connection between the wireless device 200 and the access network (e.g., eNodeB of E-UTRAN 152).

In various embodiments, the PDCP sublayer 312 may provide uplink functions including multiplexing between different radio bearers and logical channels, sequence number addition, handover data handling, integrity protection, ciphering, and header compression. In the downlink, the PDCP sublayer 312 may provide functions that include in-sequence delivery of data packets, duplicate data packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the wireless device 200. In some embodiments, application-specific functions provided by the at least one host layer 314 may provide an interface between the software architecture and the general purpose processor 206.

In other embodiments, the software architecture 300 may include one or more higher logical layer (e.g., transport, session, presentation, application, etc.) that provide host layer functions. For example, in some embodiments, the software architecture 300 may include a network layer (e.g., IP layer) in which a logical connection terminates at a PDN gateway (e.g., PGW 163). In some embodiments, the software architecture 300 may include an application layer in which a logical connection terminates at another device (e.g., end user device, server, etc.). In some embodiments, the software architecture 300 may further include in the AS 304 a hardware interface 316 between the physical layer 306 and the communication hardware (e.g., one or more RF transceivers).

Re-transmissions of missing or erroneously received data units in an LTE wireless network are handled primarily by the HARQ mechanism in the MAC layer, complemented by the ARQ retransmission functionality of the RLC layer in LTE. This two-level retransmission structure is a result of the trade-off between fast and reliable feedback of the status reports. In particular, the HARQ mechanism provides very fast retransmission which may be suitable for high speeds used in LTE, whereas the ARQ is responsible for reliability. Usually HARQ handles the majority of transmission errors but sometimes the mechanism fails, in which case ARQ may be needed.

Specifically, HARQ feedback is fast and frequent to correct transmission errors as soon as possible. In this manner, the end-to-end round trip time (RTT) for HARQ is low.

The HARQ processes may involve a synchronous one-bit ACK/NACK signal that is sent every transmission attempt, the timing of which is used by the network to identify the corresponding data transmission. However, since the binary feedback at the HARQ level is susceptible to transmission errors, the additional ARQ protocol provides a reliable (but slower) feedback. Typically, ARQ processes involve asynchronous RLC status reports that contain explicit sequence numbers, which are protected by a cyclic redundancy check (CRC). Compared to HARQ, RLC status reports in ARQ processes are transmitted relatively infrequently and thus the cost of obtaining reliability is relatively small.

Typically, problems in the physical layer for an LTE communication may lead to errors in receiving data packets, generally prompting a quick NACK reporting in HARQ to eNodeB. Conditions that create such problems may include interference, poor reception area, etc. Since such conditions generally last for a long period of time, a high-speed network may implement link adaptation and reduce the modulation and coding scheme (MCS) for the radio link. Further, the network may reduce the amount of time (e.g., resource blocks) allocated to the wireless device for the communication. As such, the throughput of the data communication is adversely affected. Typically, after a delay (e.g., 100 ms-1 s), the eNodeB may receive updated link quality information from the wireless device indicating recovery from the problem. If recovery is indicated, the link adaptation ramps up the allowed conditions for the communication, gradually restoring the data throughput.

However, operation in the diversity tune-away mode (e.g., tuning away on one receive chain while maintaining the connection in the high-speed network using the other receive chain) is relatively short in duration (referred to herein sometimes as a “tune-away gap” or “diversity tune-away (DTA) gap”). Further, once the DTA gap is ended, the communication is restored with full capability to receive data at the highest throughput, without the need to ramp up from poor channel conditions. Thus, the conventional link adaptation in high-speed networks unnecessarily penalizes/delays the wireless device following recovery from a DTA gap.

Various embodiments may implement a method for avoiding a decrease in the MCS/resource block allocation to the wireless device communication by the high-speed network, thereby avoiding the resulting decrease in throughput in the communication.

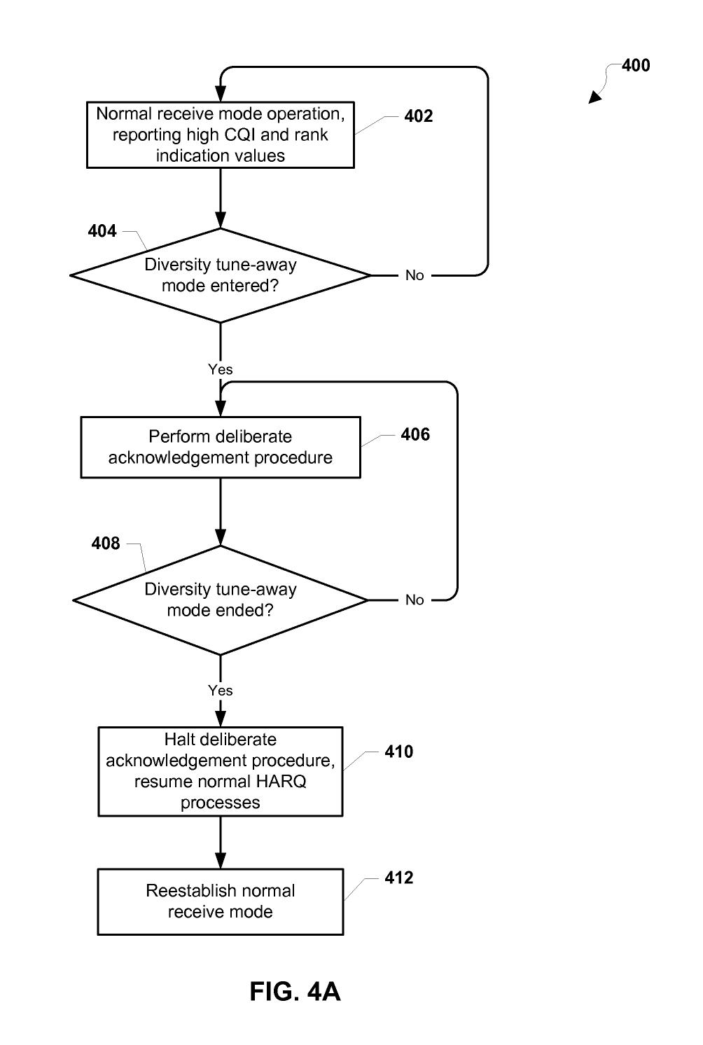

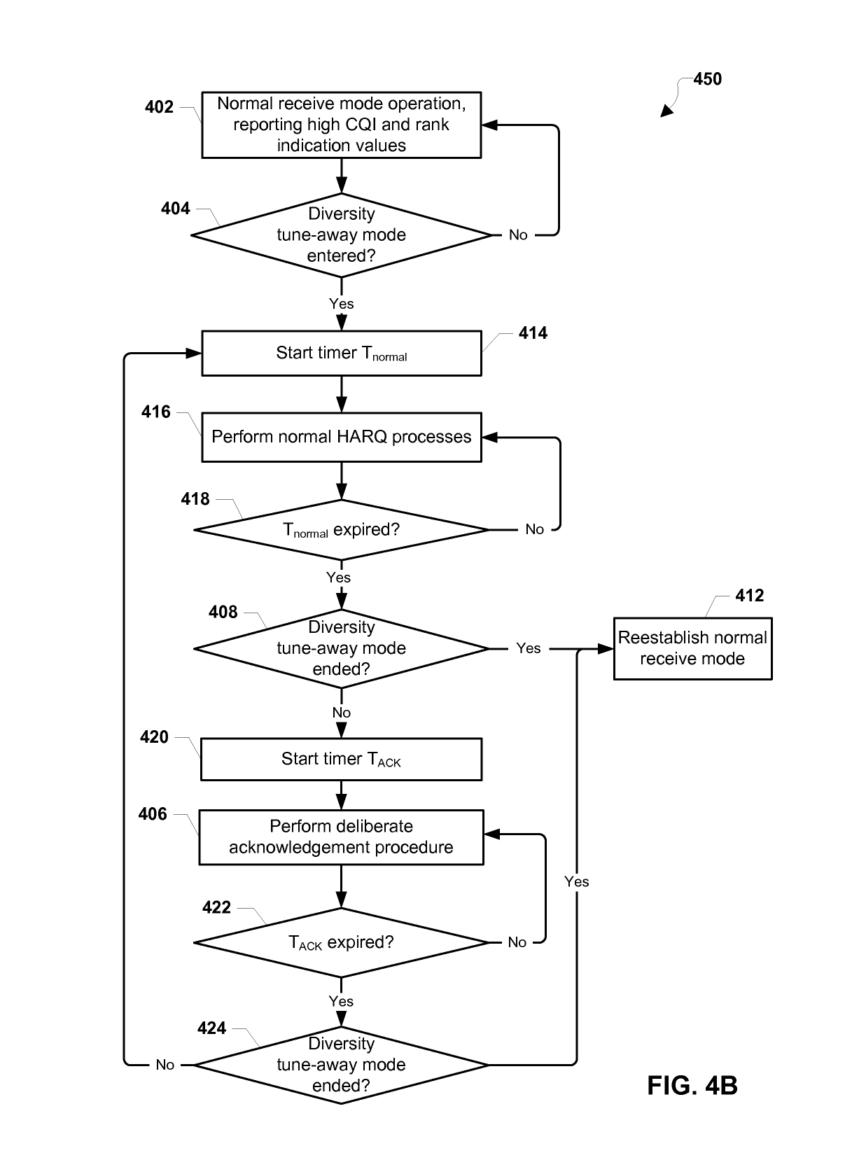

FIGS. 4A and 4B illustrate methods 400, 450 to reduce the throughput decrease during a diversity tune-away (DTA) gap on a wireless communication device according to various embodiments. With reference to FIGS. 1-4A, the operations of the method 400 may be implemented in a DTA management module by one or more processors of the wireless device 200, such as the general purpose processor 206 and/or baseband modem processor(s) 216, or a separate controller (not shown) that may be coupled to the memory 214 and to the baseband modem processor(s) 216.

While various embodiments describe the DTA management processes with respect to at least one SIM and RF resource configured with two receive chains, the various embodiment processes may be implemented to manage various combinations of two or more SIMs and/or RF resources, each of which may be associated with a plurality of receive chains.

The references to the first and second receive chains are arbitrary and used merely for the purposes of describing the embodiments. The wireless device processor may assign any indicator, name or other designation to differentiate the receive chains associated with one or more SIM and associated protocol stacks. Further, embodiment methods apply the same regardless of which receive chain is being used to tune away from the high-speed (e.g., LTE) network during the DTA gap. Further, while the high-speed network is referenced as an LTE network, the various embodiments may be implemented for receiving data in any of a variety of high-speed networks (e.g., HSPA+, DC-HSPA, EV-DO, etc.).

In block 402, the wireless device processor may be in a normal receive mode in which both a first and a second receive chain are configured to receive data in a high-speed network (e.g., an LTE network). While in the normal receive mode, the wireless device may report high channel quality indicator (CQI) and rank indication values to the base station (e.g., an eNodeB), assuming radio conditions are favorable.

In determination block 404, the wireless device may determine whether the wireless device has entered a diversity tune-away mode. In various embodiments, the transition to the diversity tune-away mode involves keeping the first receive chain tuned to the LTE network, while the second receive chain tunes away to a channel in a different radio access technology (e.g., 1×RTT, GSM, TD-SCDMA, etc.). The references to the first and second receive chains are arbitrary. In some embodiments, tuning away to the different radio access technology may involve tuning to a different communication network/system associated with another SIM in the wireless device. In some embodiments, tuning away to the different radio access technology may occur within the same system in the case of a carrier operating a hybrid system. In various embodiments, the determination of whether the wireless device has entered the diversity tune-away mode may be based on a schedule associated with another radio access technology (e.g., page decode timing), an event in the network for another radio access technology (e.g., receiving paging message), etc.

So long as the wireless device has not entered the diversity tune-away mode (i.e., determination block 404=“No”), the wireless device processor may continue to operate in the normal receive mode in block 402, and continue to report high CQI and rank indication values.

In response to determining that the wireless device is in the diversity tune-away mode (e.g., determination block 404=“Yes”), the wireless device processor may begin a deliberate acknowledgment procedure in block 406. In the deliberate acknowledgment procedure, the wireless device processor may ignore the normal HARQ processes at the MAC layer and instead deliberately send ACK messages to the eNodeB. In this manner, the wireless device may avoid being penalized by the scheduling in the eNodeB (which occurs at MAC level) based on errors in receiving packets.

However, since the data for which deliberate ACKs have been sent at the MAC layer has not in fact been received, holes in the downlink RLC sequence are necessarily formed. In order to fill such holes in time to enable the data to be recovered and avoid a data stall for TCP in-flight data sent to the wireless device, the deliberate acknowledgment procedure also involves sending an RLC status report for each missed packet, such as a fast RLC NACK for each missed packet.

The fast RLC NACK is a status report at the RLC layer for alerting the eNodeB of missed packets in a shorter period of time that is better suited to the situation during the DTA gap than that involved in the normal RLC NACK. Specifically, depending on the network configuration, one-way delay between the wireless device and the eNodeB typically varies between 30-100 ms, which causes the RLC to operate with round-trip time (RTT) as large as 200 ms. In order to control the data flow, the RLC receiver (i.e., the wireless device) typically sends status reports to the RLC transmitter (e.g., base station eNodeB), which may contain the sequence numbers of missing packets, i.e., RLC NACK. In particular, the wireless device may generate a report when the wireless device detects a gap in the sequence numbers of the received protocol data units (PDUs). Typically, since each status report contains the NACKs corresponding to all outstanding missing packets, when a status report is sent by the wireless device, the next report is not sent before waiting for at least one round trip time (RTT). The RLC employs a status-prohibit mechanism to regulate this transmission, for which a status-prohibit timer generally set to a value slightly longer than the average RTT in order to allow the RLC transmitter to perform another transmission before a new RLC NACK is generated. While this conventional RLC approach may be useful in avoiding spurious retransmissions, this approach provides unnecessarily long delays with respect to packets missed due to diversity tune-away. That is, it may be assumed that feedback to the network will be required to report any missing packets (i.e., holes in sequence numbers) for any packets that are lost within the tune-away period.

As such, in various embodiments, the fast RLC status report mechanism may be used (i.e., the “fast RLC NACK”). In various embodiments, fast RLC status reporting may involve sending RLC NACK messages as needed. Specifically, whenever the wireless device infers a missing PDU, an RLC NACK message may be sent that includes only the sequence number of that particular missing PDU. Further, it is recognized in the fast RLC status reporting that is no need to wait until a tune-away period is over or any channel conditions improve, because the wireless device is still able to transmit on the uplink during the DTA gap.

Thus, depending on the duration of the DTA gap, in various embodiments (which may cause many missed packets), the deliberate acknowledgment mode may involve sending a fast RLC NACK to the network automatically after expiration of a predetermined time period (T_{FastNACKPeriod}).

In various embodiments, the wireless device processor may continue the deliberate acknowledgment procedure throughout the duration of the DTA gap. In determination block 408, the wireless device processor may determine whether the DTA gap is ended by determining whether the diversity tune-away mode has ended on the wireless device. So long as the diversity tune-away mode has not ended (i.e., determination block 408=“No”), the wireless device processor may continue the deliberate acknowledgment procedure in block 406.

In response to determining that the wireless device has transitioned out of the diversity tune-away mode (i.e., determination block 408=“Yes”), the wireless device processor may halt the deliberate acknowledgment procedure and resume normal error detection (e.g., HARQ processes) in block 410. In block 412, the wireless device processor may reestablish the normal receive mode (i.e., both receive chains tuned to the LTE network). In this manner, the wireless device may avoid being penalized by the network following the end of the DTA gap, and may immediately receive data at high throughput from the LTE network.

By using the deliberate acknowledgment procedure throughout the duration of the gap, the LTE network is necessarily unaware of the tune-away since the LTE network has no other mechanism by which to receive that information. As a result, by deliberately sending ACK messages to the eNodeB regardless of whether true, the LTE network may be deprived of the ability to implement an intelligent tune-away solution.

Therefore, in some embodiments, during the DTA gap the wireless device processor may alternate between periods of normal HARQ processes and the deliberate acknowledgment procedure lasting predetermined times, as provided in the method 450 illustrated in FIG. 4B.

With reference to FIGS. 1-4B, the operations of the method 450 may be implemented in a DTA management module by one or more processors of the wireless device 200, such as the general purpose processor 206 and/or baseband modem processor(s) 216, or a separate controller (not shown) that may be coupled to the memory 214 and to the baseband modem processor(s) 216. The method 450 may begin with the operations in block 402 and determination block 404 of the method 400 as described. So long as the wireless device has not entered the diversity tune-away mode (i.e., determination block 404=“No”), the wireless device processor may continue to operate in the normal receive mode reporting high CQI and ranking indication values in block 402.

In response to determining that the wireless device is in the diversity tune-away mode (i.e., determination block 404=“Yes”), the wireless device processor may start a first timer, also referred to as “Tₙₒᵣₘₐₗ” in block 414. The duration of the timer Tₙₒᵣₘₐₗ may be set, for example, to around 20-30 ms. In some embodiments, the duration of the timer Tₙₒᵣₘₐₗ may be set according to network standards and/or configured manually, for example, by a user of the wireless device, manufacturer, etc. In some embodiments, the duration of the timer Tₙₒᵣₘₐₗ may be dynamically changed based, for example, on current radio/network conditions, etc.

In block 416, the wireless device processor may perform normal HARQ processes as if operating in the normal receive mode as described.

In determination block 418, the wireless device processor may determine whether the timer Tₙₒᵣₘₐₗ has expired. So long as the timer Tₙₒᵣₘₐₗ has not expired (i.e., determination block 418=“No”), the wireless device processor may continue to operate by performing normal HARQ processes in block 416. In response to determining that the timer Tₙₒᵣₘₐₗ has expired (i.e., determination block 418=“Yes”), the wireless device processor may determine whether the DTA gap has ended by determining whether the diversity tune-away mode has ended in block 408 (e.g., as described in the method 400). So long as the diversity tune-away mode has not ended (i.e., determination block 408=“No), the wireless device processor may start a second timer, also referred to as “T_{ACK}” in block 420. The duration of the timer T_{ACK} may be set, for example, to around 10-20 ms. In some embodiments, similar to the timer Tₙₒᵣₘₐₗ, the duration of the timer T_{ACK} may be set according to network standards and/or configured manually, for example, by a user of the wireless device, manufacturer, etc. In some embodiments, the duration of the timer T_{ACK} may be set automatically by the DTA management module, which may be configured to dynamically change the duration. In various embodiments, the predetermined times Tₙₒᵣₘₐₗ and T_{ACK} may be implemented as back-off timers.

The wireless device processor may begin the deliberate acknowledgment procedure in block 406 (e.g., as described in the method 400). In determination block 422, the wireless device processor may whether T_{ACK} has expired. So long as the timer T_{ACK} has not expired (i.e., determination block 422=“No”), the wireless device processor may continue performing the deliberate acknowledgment procedure in block 406.

In response to determining that the timer T_{ACK} has expired (i.e., determination block 422=“Yes”), the wireless device processor may again determine whether the DTA gap has ended by determining whether the diversity tune-away mode has ended on the wireless device in determination block 424. So long as the diversity tune-away mode has not ended (i.e., determination block 424=“No”), the wireless device processor may return to start the timer Tₙₒᵣₘₐₗ in block 414. In this manner, the wireless device processor may continue alternating between periods of normal HARQ operation and the deliberate acknowledgment procedure until the end of the DTA gap.

In response to determining that the wireless device processor has transitioned out of the diversity tune-away mode (i.e., determination block 408=“Yes” or determination block 424=“Yes”), the wireless device processor may reestablish normal receive mode in block 412 (e.g., as described in the method 400).

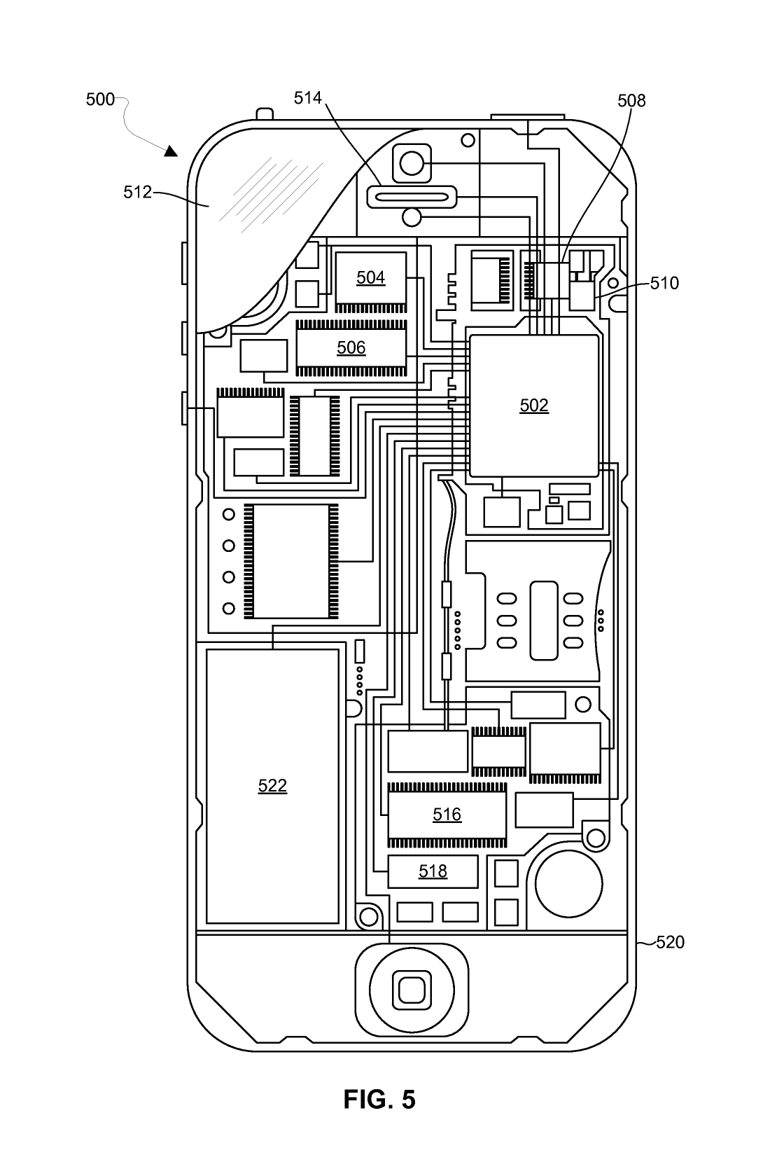

Various embodiments (including, but not limited to, the embodiments described with reference to FIGS. 4A and 4B) may be implemented in any of a variety of wireless devices, an example 500 of which is illustrated in FIG. 5. With reference to FIGS. 1-5, the wireless device 500 (which may correspond, for example, to the wireless devices 102 and/or 200 in FIGS. 1A-2) may include a processor 502 coupled to a touchscreen controller 504 and an internal memory 506. The processor 502 may be one or more multicore ICs designated for general or specific processing tasks. The internal memory 506 may be volatile or non-volatile memory, and may also be secure and/or encrypted memory, or unsecure and/or unencrypted memory, or any combination thereof.

The touchscreen controller 504 and the processor 502 may also be coupled to a touchscreen panel 512, such as a resistive-sensing touchscreen, capacitive-sensing touchscreen, infrared sensing touchscreen, etc. The wireless device 500 may have one or more radio signal transceivers 508 (e.g., Peanut®, Bluetooth®, Zigbee®, Wi-Fi, RF radio) and antennas 510, for sending and receiving, coupled to each other and/or to the processor 502. The transceivers 508 and antennas 510 may be used with circuitry in various embodiments to implement the various wireless transmission protocol stacks and interfaces. The wireless device 500 may include a cellular network wireless modem chip 516 that enables communication via a cellular network and is coupled to the processor. The wireless device 500 may include a peripheral device connection interface 518 coupled to the processor 502. The peripheral device connection interface 518 may be singularly configured to accept one type of connection, or multiply configured to accept various types of physical and communication connections, common or proprietary, such as USB, FireWire, Thunderbolt, or PCIe. The peripheral device connection interface 518 may also be coupled to a similarly configured peripheral device connection port (not shown). The wireless device 500 may also include speakers 514 for providing audio outputs. The wireless device 500 may also include a housing 520, constructed of a plastic, metal, or a combination of materials, for containing all or some of the components discussed herein. The wireless device 500 may include a power source 522 coupled to the processor 502, such as a disposable or rechargeable battery. The rechargeable battery may also be coupled to the peripheral device connection port to receive a charging current from a source external to the wireless device 500.

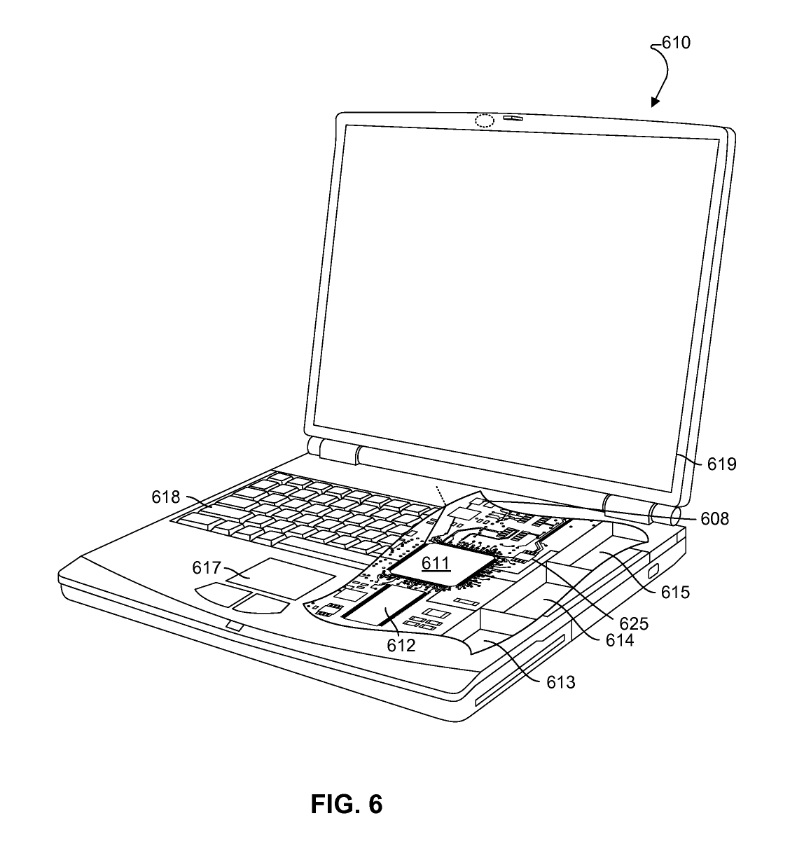

Various embodiments (including, but not limited to, the embodiments discussed with reference to FIGS. 4A and 4B), may also be implemented within a variety of personal computing devices, an example 600 of which is illustrated in FIG. 6. With reference to FIGS. 1-6, the laptop computer 600 (which may correspond, for example, to the wireless devices 102,200 in FIGS. 1A-2) may include a touchpad touch surface 617 that serves as the computer's pointing device, and thus may receive drag, scroll, and flick gestures similar to those implemented on wireless computing devices equipped with a touchscreen display as described. A laptop computer 600 will typically include a processor 611 coupled to volatile memory 612 and a large capacity nonvolatile memory, such as a disk drive 613 of Flash memory. The computer 600 may also include a floppy disc drive 614 and a compact disc (CD) drive 615 coupled to the processor 611. The computer 600 may also include a number of connector ports coupled to the processor 611 for establishing data connections or receiving external memory devices, such as a USB or FireWire® connector sockets, or other network connection circuits for coupling the processor 611 to a network. In a notebook configuration, the computer housing includes the touchpad 617, the keyboard 618, and the display 619 all coupled to the processor 611. Other configurations of the computing device may include a computer mouse or trackball coupled to the processor (e.g., via a USB input) as are well known, which may also be used in conjunction with various embodiments.

With reference to FIGS. 1-6, the processors 502 and 611 may be any programmable microprocessor, microcomputer or multiple processor chip or chips that can be configured by software instructions (applications) to perform a variety of functions, including the functions of various embodiments as described. In some devices, multiple processors may be provided, such as one processor dedicated to wireless communication functions and one processor dedicated to running other applications. Typically, software applications may be stored in the internal memory 506, 612 and 613 before they are accessed and loaded into the processors 502 and 611. The processors 502 and 611 may include internal memory sufficient to store the application software instructions. In many devices the internal memory may be a volatile or nonvolatile memory, such as flash memory, or a mixture of both. For the purposes of this description, a general reference to memory refers to memory accessible by the processors 502, 611, including internal memory or removable memory plugged into the device and memory within the processor 502 and 611, themselves.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

While the terms “first” and “second” are used herein to describe data transmission associated with a SIM and data receiving associated with a different SIM, such identifiers are merely for convenience and are not meant to limit the various embodiments to a particular order, sequence, type of network or carrier.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of various embodiments are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present invention is not intended to be limited to the embodiments shown herein but is to be accorded the widest scope consistent with the following claims and the principles and novel features disclosed herein.

What is claimed is:

1. A method of managing downlink data throughput in a wireless communication device having at least one radio frequency (RF) resource configured with at least a first and second receive chain that are both associated with a connection in a data network, the method comprising:
determining whether a diversity tune-away mode is entered;
performing a deliberate acknowledgment procedure in response to determining that the diversity tune-away mode is entered, wherein performing the deliberate acknowledgment procedure comprises:
ignoring normal error detection for data received in a communication and sending an acknowledgment message for received data to the data network; and
determining whether the diversity tune-away mode has ended on the wireless communication device; and
halting the deliberate acknowledgment procedure and resuming normal error detection for the received data in response to determining that the diversity tune-away mode has ended.

2. The method of claim 1, further comprising monitoring data communications and downlink channel conditions in the data network.

3. The method of claim 1, wherein entering the diversity tune-away mode comprises maintaining an association of the first receive chain with the connection to the data network, and tuning the second receive chain to a channel in a different network.

4. The method of claim 3, wherein:
the at least one RF resource is configured to be coupled to a first subscriber identity module (SIM) and a second SIM;
the first SIM supports a first second radio access technology (RAT), wherein the first RAT is associated with the data network; and
tuning to the second receive chain to the channel in the different network comprises using the second receive chain to enable a connection in a second RAT associated with the second SIM.

5. The method of claim 4, wherein determining whether a diversity tune-away mode is entered is based on a schedule or event associated with the second RAT.

6. The method of claim 1, further comprising:
reestablishing a normal receive mode on the wireless communication device by tuning the second receive chain to a channel associated with the connection in the data network.

7. The method of claim 1, further comprising:
continuing the deliberate acknowledgment procedure throughout a diversity tune-away gap, wherein the diversity tune-away gap lasts until the diversity tune-away mode ends.

8. The method of claim 1, wherein the data network comprises a network configured to use long term evolution (LTE) wireless communication protocols.

9. The method of claim 8, wherein:
ignoring normal error detection for received data comprises bypassing diversity automatic repeat request (HARQ) processes implemented by a media access control (MAC) protocol stack layer; and
sending an acknowledgment message for the received data comprises deliberately sending to the data network acknowledgment (ACK) messages at the MAC protocol stack layer regardless of errors in the received data.

10. The method of claim 9, wherein performing the deliberate acknowledgment procedure further comprises triggering sending a status report message at a radio link control (RLC) protocol stack layer, wherein the status report message alerts the data network of missed data packets.

11. The method of claim 10, wherein sending the status report message at the RLC protocol stack layer comprises periodically sending a fast RLC non-acknowledgment (NACK) message to the network automatically after each expiration of a predetermined time period.

12. The method of claim 1, further comprising:
starting a first timer that lasts a first preset period of time in response to determining that the diversity tune-away mode has been entered;
determining whether the first preset period of time has expired;
performing normal error detection for the received data in response to determining that the first preset period of time has not expired; and
performing the deliberate acknowledgment procedure in response to determining that the first preset period of time has expired.

13. The method of claim 12, further comprising:
starting a second timer that lasts a second preset period of time, upon expiration of the first preset period of time;
determining whether the second preset period of time has expired;
performing the deliberate acknowledgment procedure for the received data in response to determining that the second preset period of time has not expired; and
resuming performing the normal error detection for the received data in response to determining that the second preset period of time has expired.

14. The method of claim 13, further comprising repeating the first and second preset periods of time to alternate performing the normal error detection processes and the deliberate acknowledgment procedure for a duration of the diversity tune-away gap.

15. The method of claim 13, wherein the first preset period of time is within a range of around 20-30 ms, and wherein the second preset period of time is within a range of around 10-20 ms.

16. A wireless communication device, comprising:
a radio frequency (RF) resource configured with at least a first and a second receive chain that are both associated with a connection in a data network; and
a processor coupled to the RF resource and configured with processor-executable instructions to:
determine whether a diversity tune-away mode is entered;
enter the diversity tune-away mode by performing a deliberate acknowledgment procedure in response to determining to that the diversity tune-away mode is entered, wherein performing the deliberate acknowledgment procedure comprises:
ignoring normal error detection for data received in a communication and sending an acknowledgment message for received data to the data network; and
determining whether the diversity tune-away mode has ended on the wireless communication device; and
halt the deliberate acknowledgment procedure and resuming normal error detection for the received data in response to determining that the diversity tune-away mode has ended.

17. The wireless communication device of claim 16, wherein the processor is further configured with processor-executable instructions to enter the diversity tune-away mode by:
maintaining an association of the first receive chain with the connection to the data network; and
tuning the second receive chain to a channel in a different network.

18. The wireless communication device of claim 17, wherein:
the RF resource is configured to be coupled to a first subscriber identity module (SIM) and a second SIM;
the first SIM supports a first second radio access technology (RAT), wherein the first RAT is associated with the data network; and
the processor is further configured with processor-executable instructions to tune to the second receive chain to the channel in the different network by using the second receive chain to enable a connection in a second RAT associated with the second SIM.

19. The wireless communication device of claim 18, wherein the processor is further configured with processor-executable instructions to determine whether the diversity tune-away mode is entered based on a schedule or event associated with the second RAT.

20. The wireless communication device of claim 16, wherein the processor is further configured with processor-executable instructions to reestablish a normal receive mode by tuning the second receive chain to a channel associated with the connection in the data network.

21. The wireless communication device of claim 16, wherein the processor is further configured with processor-executable instructions to continue the deliberate acknowledgment procedure throughout a diversity tune-away gap, wherein the diversity tune-away gap lasts until the diversity tune-away mode is ended.

22. The wireless communication device of claim 16, wherein the processor is further configured with processor-executable instructions to:
ignore normal error detection for received data comprises bypassing diversity automatic repeat request (HARQ) processes implemented by a media access control (MAC) protocol stack layer; and
send an acknowledgment message for the received data comprises deliberately sending to the data network acknowledgment (ACK) messages at the MAC protocol stack layer regardless of errors in the received data.

23. The wireless communication device of claim 22, wherein the processor is further configured with processor-executable instructions to perform the deliberate acknowledgment procedure by triggering sending a status report message at a radio link control (RLC) protocol stack layer, wherein the status report message alerts the data network of missed data packets.

24. The wireless communication device of claim 23, wherein the processor is further configured with processor-executable instructions to send the status report message at the RLC protocol stack layer by periodically sending a fast RLC non-acknowledgment (NACK) message to the data network automatically after each expiration of a predetermined time period.

25. The wireless communication device of claim 16, wherein the processor is further configured with processor-executable instructions to:
start a first timer that lasts a first preset period of time in response to determining that the diversity tune-away mode has been entered;
determine whether the first preset period of time has expired;
perform normal error detection for received data in response to determining that the first preset period of time has not expired; and
perform the deliberate acknowledgment procedure in response to determining that the first preset period of time has expired.

26. The wireless communication device of claim 25, wherein the processor is further configured with processor-executable instructions to:
start a second timer that lasts a second preset period of time upon expiration of the first preset period of time;
determine whether the second preset period of time has expired;
perform the deliberate acknowledgment procedure for the received data in response to determining that the second preset period of time has not expired; and
resume performing the normal error detection processes for the received data in response to determining that the second preset period of time has expired.

27. A wireless communication device, comprising:
a radio frequency (RF) resource configured with at least a first and a second receive chain that are both associated with a connection in a data network; and
means for determining a diversity tune-away mode is entered;
means for performing a deliberate acknowledgment procedure in response to determining that the diversity tune-away mode is entered, wherein means for performing the deliberate acknowledgment procedure comprises:
means for ignoring normal error detection for data received in a communication and sending an acknowledgment message for received data to the data network; and
means for determining whether the diversity tune-away mode has ended on the wireless communication device; and
means for halting the deliberate acknowledgment procedure and resuming normal error detection for the received data in response to determining that the diversity tune-away mode has ended.

28. A non-transitory processor-readable storage medium having stored thereon processor-executable instructions configured to cause a processor of a wireless communication device having a radio frequency (RF) resource configured with at least a first and a second receive chain that are associated with a connection in a data network to perform operations comprising:
determining whether a diversity tune-away mode is entered;
performing a deliberate acknowledgment procedure in response to determining that the diversity tune-away mode is entered, wherein performing the deliberate acknowledgment procedure comprises:
ignoring normal error detection for data received in a communication and sending an acknowledgment message for received data to the data network; and
determining whether the diversity tune-away mode has ended on the wireless communication device; and
halting the deliberate acknowledgment procedure and resuming normal error detection for the received data in response to determining that the diversity tune-away mode is ended.
